(19) United States
(12) Patent Application Publication
(10) Pub. No.: US 2006/0024472 A1
(43) Pub. Date: Feb. 2, 2006

(54) Connection of the edges of formed sheets

(76) Inventor: Alfred Losch, Tholey Hasborn (DE)

Correspondence Address: McGlew and Tuttle, Scarborough Station, Scarborough, NY, 10510-0827, US

(21) Appl. No.: 10/522,931

(22) PCT Filed: Jun. 14, 2003
(86) PCT No.: PCT/EP03/06304

§ 371 Date: Jan. 24, 2005

(30) Foreign Application Priority Data
Aug. 3, 2002 (DE) 202 11 948.3

(51) Int. Cl. B32B 3/06

(52) U.S. Cl. 428/99; 428/122

(57) ABSTRACT

A connection of the edges of formed sheets, preferably of a door outer sheet (1) to a door inner sheet and/or a connecting sheet (2) is provided, wherein the edges of the sheets have at least partly planar contact surfaces and may be detachably connected to one another. Provisions are made for the areas of the edges of the sheets lying on top of each other to have strips, straps (3) and/or flanges (4) bent inwardly and/or at least in the same direction for the detachable connection of the sheets by means of screw connections (5) and/or clamping strips (7-11).

### CROSS REFERENCE TO RELATED APPLICATIONS

This application is a United States National Phase application of International Application PCT/EP2003/006304 and claims the benefit of priority under 35 U.S.C. § 119 of German Application DE 202 11 948.3 filed Aug. 3, 2002, the entire contents of which are incorporated herein by reference.

### FIELD OF THE INVENTION

The present invention pertains to a connection of the edges of formed sheets preferably of a door outer sheet with a door inner sheet and/or with a connecting sheet, wherein the edges of the sheets have at least partially planar contact and can be detachably connected with one another.

### BACKGROUND OF THE INVENTION

The door outer sheet and the door inner sheet of motor vehicles are usually connected with one another by spot welding, tacking and tacking adhesive, whereby a permanent connection is established, which can usually be detached only by destroying or damaging the door outer sheet. The tacked doors are inserted into the body at the stage of the bodyshell. This makes difficult the current concepts of subcontracting the processing of already painted doors equipped with accessories. The goal is therefore to connect the inner door built up and painted separately with the door outer skin after the painting of the body and the door outer skin and to subsequently connect it with the body.

### SUMMARY OF THE INVENTION

The basic object of the present invention is therefore to provide a detachable connection of the edges of such sheets, in which the tacking technique can be done away with.

According to the present invention a connection of the edges of formed sheets preferably of a door outer sheet with a door inner sheet and/or with a connecting sheet is provided wherein the edges of the sheets have at least partially planar contact and can be detachably connected with one another. For the areas of the edges of the sheets lying on top of each other to have strips, straps and/or flanges are provided bent inwardly and/or at least in the same direction for the detachable connection of the sheets by means of screw connections and/or clamping strips.

The edges of the sheets may be preferably manufactured by edging and designed such that mounting straps arranged approximately at right angles to the plane of the sheet are present, distributed on the circumference preferably on the door outer skin, and the mounting straps can be fitted together into the inner sheet at opposite mounting flanges of the inner sheet and/or of a connecting sheet and detachably connected by means of a screw connection. Instead of or also in addition to the screw connection, the straps and flanges of the edges of the sheets may also be surrounded by a U-shaped clamping strip, preferably one made of plastic, which can be attached from the outside. It proved to be favorable in case of the use of clamping strips to have not only straps and flanges distributed on the circumference at the sheet edges, but also bent strips, which extend fully or partially over the circumference of the sheet edges. It is now also possible to use longer clamping strips, which preferably extend over the entire circumference or at least over a large part of the circumference. If these clamping strips have a greater length, they must, of course, be made correspondingly elastic or articulated for adaptation to the contours of the sheet edges. To stabilize the plastic clamping strip, it proved to be favorable if the plastic clamping strip has an inner metal core, which additionally holds the plastic strip on the connection.

As an alternative or in addition to the screw connection, the clamping strip may also be “clipped” or fixed by means of a clipping device in a common opening in the edges of the sheets.

Besides the two sheet edges and optionally also the plastic clamping strip, the joint sealing can also be screwed by means of the screw connection. As a result, the door outer sheet is connected with both the door inner sheet or with a connecting sheet and the joint sealing. However, the joint sealing may also be integrated in the plastic clamping strip such that both are permanently connected with one another already at the time of the manufacture. In this case, the joint sealing does not need to be directly included in the screw connection any longer.

Finally, it also proved to be favorable to design the clamping strips such that they act as cover strips at the same time and even assume the outer sealing function itself. These cover strips can then be brought into contact with the door outer sheet in a suitable manner, e.g., elastically, and be in contact on the other side, e.g., with the glass or the rocker panel.

The connection according to the present invention has the following advantages:
Elimination of the tacking unit,
   the new concept of the separate painting of the door outer skin and the inner door can be applied,
   a connecting sheet may be bonded, soldered or welded to the door inner sheet or permanently connected with same in another manner, i.e., no screw connection is necessary, because the connecting sheet and the door outer skin are detachably connected with one another,
the outer skin, which is removable as an individual part, offers increased repair-friendliness, and
joint sealings can be integrated in cover profiles and clamping strips in a simple manner.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

The present invention will be explained in greater detail below as an example on the basis of FIGS. 1 through 8 attached. In the drawings:

FIG. 1 is the view of a locally screwed outer skin 1 in the area of the C pillar of a passenger car;

FIG. 2 is an enlarged detail “X” from FIG. 1;

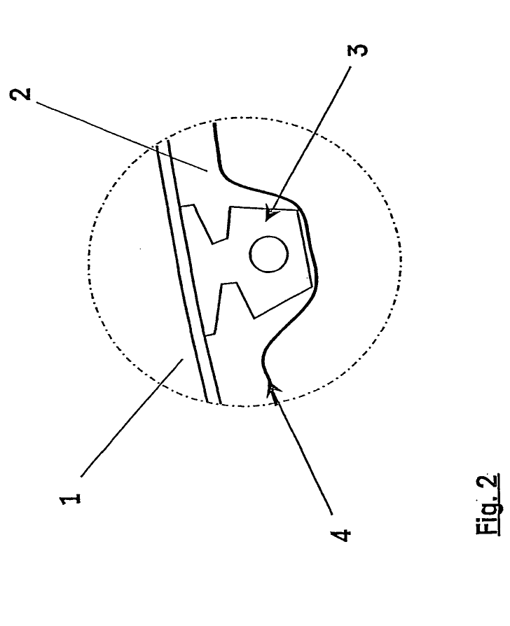

FIG. 3 is the edge connection of a locally screwed outer skin 1 in the area of the C pillar;

FIG. 4 is an arrangement corresponding to that in FIG. 3 with a clamping strip 8 and joint sealing 13 integrated in the clamping strip;

FIG. 5 is an arrangement corresponding to FIG. 3 with a clamping strip 7 and joint sealing 12 integrated in the clamping strip for the area of a B column;

FIG. 6 is a connection from the area of the window channel with a clamping and cover strip 9 with integrated metal core 15 (without screw connection);

FIG. 7 is a connection with a clamping and cover strip 10 with integrated metal core 16 and an outer sealing 17 made integrally in one piece for the area of the rocker panel of a door; and

FIG. 8 is a connection of a clipped clamping and cover strip 11 with an outer sealing 18 made integrally in one piece, likewise in the area of a rocker panel of a door.

### DESCRIPTION OF THE PREFERRED EMBODIMENTS

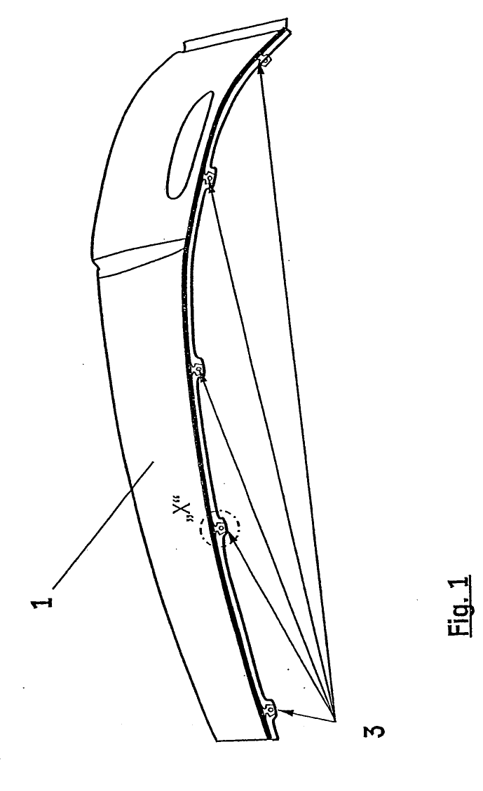

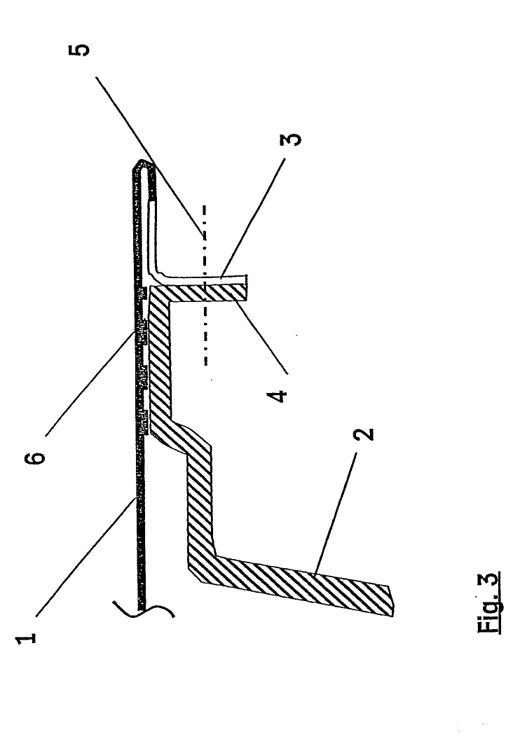

Referring to the drawings in particular, FIG. 1 shows the arrangement of various mounting straps 3 on a door outer skin 1. The corresponding mounting flanges 4 of a connecting sheet 2 and the corresponding straps 3 on the door outer skin 1 are connected with one another with by a screw connection 5 shown in FIG. 3. A sealing adhesive 6 is introduced in the area of the planar contact to seal the door outer skin 1 and the connecting sheet 2.

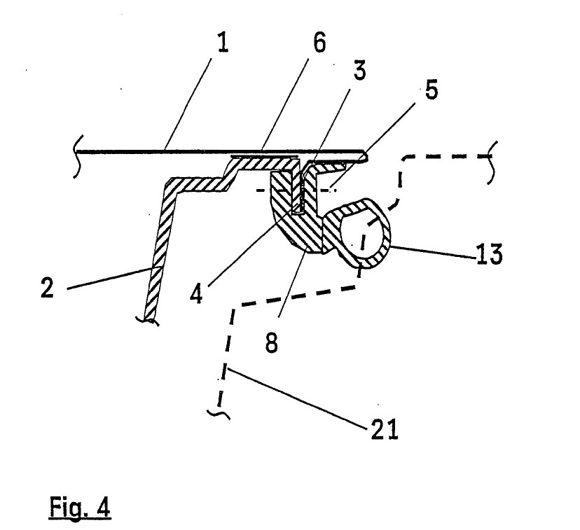

Compared to FIG. 3, FIG. 4 shows a U-shaped clamping strip 8 additionally placed on the bent edges of the sheets 1 and 2 and rigidly connected with the screw connection 5. The joint sealing 13 is rigidly connected with the plastic clamping strip 8 at the time of the manufacture thereof or joint sealing 13 may be connected with the plastic clamping strip 8 later. The broken line 21 in FIG. 4 indicates the adjoining contour of the C pillar, which is pressed by the joint sealing 13 with the door closed.

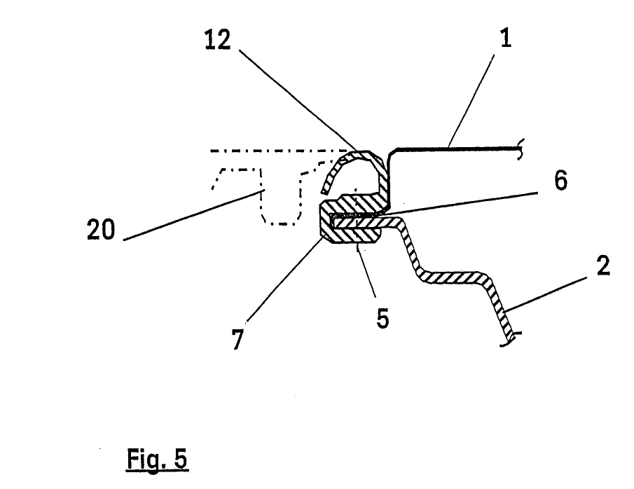

FIG. 5 shows the adjoining B pillar, designated by reference number 20, with which the joint sealing 12 is in contact. In addition, the clamping strip 7 with the integrated joint sealing 12 is connected in FIG. 5 with the edges of the sheets 1 and 2 by means of a screw connection. A sealing adhesive 6 is in turn present between the two sheets 1, 2 for additional sealing.

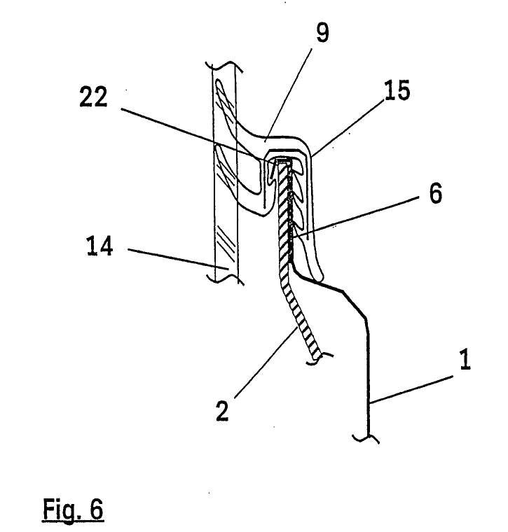

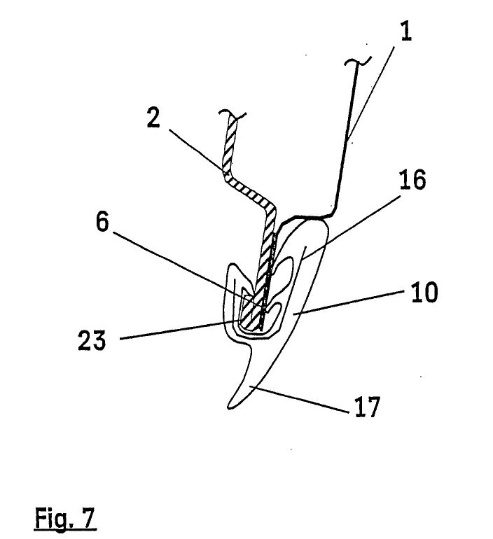

The screw connection 5 has been eliminated in FIGS. 6 through 8. The clamping strips 9 and 10 have, instead, an integrated metal core 15, 16 in FIGS. 6 and 7, and the edges of the sheets 1 and 2 are held together by means of the metal core. In addition, the outer edge of the sheet 1 is bent in FIG. 6 to the extent that it slightly surrounds the outer edge. At the same time, the bent outermost edge 22 of the sheet 1 may act as a retaining means for the clamping strip 9. The bent outer edge 23 of the sheet 2 may similarly act according to FIG. 7 as a retaining means for the clamping strip 10. As is apparent from FIG. 6, the clamping strip 9 additionally has elastic sealing lips, which are in contact with the pane 14.

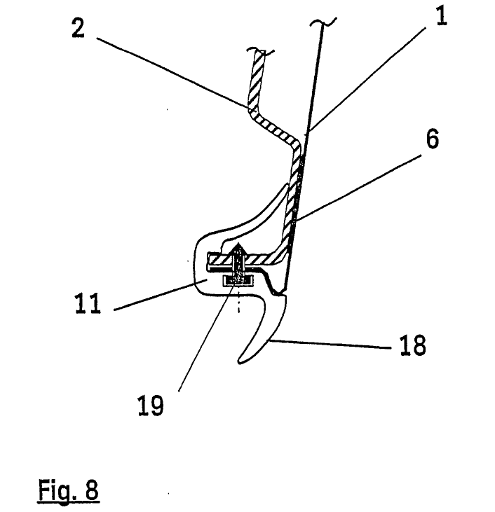

Outer sealings 17 and 18, which come into contact with the door sill, not shown, are present in FIGS. 7 and 8.

According to FIG. 8, the clamping strip 11 is held at the bent edges of the sheets 1 and 2 by means of the clipping device 19, so that retaining means similar to that for the edges 22 and 23 according to FIGS. 6 and 7 can be eliminated.

While specific embodiments of the invention have been shown and described in detail to illustrate the application of the principles of the invention, it will be understood that the invention may be embodied otherwise without departing from such principles.

1. A connection of the edges of formed sheets, preferably of a door outer sheet with a door inner sheet and/or with a connecting sheet, wherein the edges of said sheets have at least partially planar contact and can be detachably connected with one another, the connection comprising: strips, straps and/or flanges associated with the areas of said edges of said sheets lying on top of each other said strips, straps and/or said flanges being bent inwardly and/or at least in the same direction; and a detachable connection of said sheets by means of screw connections and/or clamping strips.

2. A connection in accordance with claim 1, wherein said clamping strips have at least partly a U-shaped design.

3. A connection in accordance with claim 1, wherein said clamping strips consist of a plastic.

4. A connection in accordance with claim 1, wherein said clamping strips have said metal cores.

5. A connection in accordance with claim 1, wherein said clamping strips and said edges of said sheets to be connected to one another are connected to one another by means of said screw connection and/or by means of a clipping device.

6. A connection in accordance with claim 5, wherein said joint sealing is also connected together with said clamping strip and said edges of said sheets to be connected by means of a screw connection and/or a clipping device.

7. A connection in accordance with claim 1, wherein a joint sealing is integrated in said clamping strip.

8. A connection in accordance with claim 1, wherein said clamping strips are designed at the same time as said cover strips and/or as a outer sealing.

9. A connection in accordance with claim 1, wherein said clamping strips extend fully or partially over the circumference of said edges of said sheets.

10. A formed sheet edge connection, comprising:
a first sheet with an edge having an at least partially planar contact region flange;
a second sheet with an edge having an at least partially planar contact region flange, said first sheet flange lying on top of said second sheet flange with said flanges being bent in the same direction; and
a clamping strip providing a detachable connection of said sheets at said flanges; and
one of a screw connection and a clipping device for connecting said clamping strips and said flanges of said sheets being connected to one another by means of said.

11. A connection in accordance with claim 10, wherein said clamping strips have at least partly a U-shaped design.

12. A connection in accordance with claim 10, wherein said clamping strips consist of a plastic.

13. A connection in accordance with claim 10, wherein said clamping strips have metal cores.

14. A connection in accordance with claim 10, wherein said clamping strip receive an end of said clipping device in a positive locking manner and said clipping device has an opposite end positively locked on a side of said flanges to clamp said flanges toegther with said clamping strip.

15. A connection in accordance with claim 14, further comprising a joint sealing connected together with said clamping strip and said edges of said sheets to be connected by means of a screw connection and/or a clipping device.

16. A connection in accordance with claim 10, wherein a joint sealing is integrated in said clamping strip.

17. A connection in accordance with claim 10, wherein said clamping strips are designed at the same time as said cover strips and/or as a outer sealing.

18. A connection in accordance with claim 10, wherein said clamping strips extend fully or partially over the circumference of said edges of said sheets.
